(19) United States
(12) Patent Application Publication
(10) Pub. No.: US 2016/0207218 A1
(43) Pub. Date: Jul. 21, 2016

(54) Method of cutting a decorative pattern along the top edge of a baseboard

(71) Applicant: Kenneth Drum, Apple Valley, CA (US)

(72) Inventor: Kenneth Drum, Apple Valley, CA (US)

(21) Appl. No.: 14/599,864

(22) Filed: Jan. 19, 2015

(51) Int. Cl. B27C 5/10; G05B 19/414; G06F 17/50; B44C 1/22

(52) U.S. Cl. CPC B27C 5/10; B44C 1/222; G05B 19/4145; G06F 17/50

(57) ABSTRACT

A method for manufacturing a baseboard with a decorative pattern along its top edge. A decorative pattern is first designed using Computer Aided Drafting (CAD) software that encapsulates the decorative pattern and is subsequently saved to a computer file that is readable by the CAD software. The CAD software file is then converted into a sequence of codes, normally G-Code, using a software conversion utility and the resulting sequence of codes is then loaded into a Computer Numeric Controller (CNC) machine. Wood material to be used in producing the baseboard(s) is placed onto the CNC machine and the CNC machine's numeric controller then executes the previously loaded sequence of codes to produce one or more baseboards with a decorative pattern along its top edge from the wood material loaded onto the CNC machine.

### BACKGROUND OF THE INVENTION

1. Field of the Invention

The present invention relates generally to wall structures, and in particular, baseboards or wall bases. The invention relates more specifically to a method for cutting a pattern along the top edge of a baseboard. This method substantially improves the appearance of baseboard by cutting a pattern containing hearts, waves, animals, and others, along the top edge of the baseboard so as to complement the decor of the room.

2. Description of the Related Art

Many individuals derive a sense of pride when utilizing baseboards as part of the decor of a room within their home. Baseboards serve multiple purposes when added to a room. First baseboards disguise or conceal imperfections at the junction of the flooring and the upstanding walls of the room. Second baseboards protect the lower portion of the wall from impact by furniture, shoes, and appliances such as vacuums or carpet cleaners. Third the installation of baseboards within a room provide that room with a finished look as edges are softened. Finally, the most important purpose of a baseboard is to add to the room's decor.

Baseboards come in a variety of different decorative effects however the means of applying a decorative effect to a baseboard comprised of wood or wood fibers are basically limited to two approaches.

The first approach is to use a baseboard with multiple components. The key component is a generic baseboard with certain features, such as cutouts, that allow for the addition of other components that provide the decorative effect. US patent publication 2005/0257485 teaches a baseboard with a decorative front surface that also contains a horizontal groove for accepting a decorative filler strip of different sizes and shapes. U.S. Pat. No. 7,168,474 teaches a baseboard with a front surface that may accommodate one or more interchangeable decorative modules. However these approaches do not teach a means to decorate the top edge of a baseboard and as such the top edge of the baseboard as taught remains a simple linear surface.

The second approach makes use of wood molding machinery that applies a decorative pattern to the front of a baseboard by pressing the pattern onto the front surface of the baseboard. International patent publication WO 98/48992 teaches a means whereby wood fiber boards, known in the art as medium density fiberboard or MDF, are taken through a process whereby they are softened by a combination of heat and moisture and then passed into a molding chamber where a decorative pattern is pressed onto the front surface of the MDF and then subsequently the MDF is cut into strips according to the boundaries of the pressed decorative patterns. U.S. Pat. No. 7,195,686 teaches a process similar to that described by WO 98/48992 and adds to it additional layers of material to the base material comprised of MDF, such as a veneer layer of a wood product, that are bonded together by a pressing operation. However these approaches do not teach a method to decorate to top edge of a baseboard with a pattern and as such the top edge of the baseboard as taught remains a simple linear surface.

The approaches described above teach how to apply a decorative pattern to the front surface of a baseboard but do not teach how to apply a decorative pattern to the top edge of a baseboard. Although baseboards with a decorative front surface are commonly used to finish a room it may be desirable install baseboards with a decorative top edge containing patterns of hearts, waves, or animals. However a method to fabricate a baseboard with a decorative top edge has not been disclosed by the prior art.

In light of the above, it is an object of the present invention to provide a method for applying a decorative pattern to the top edge of multiple baseboards that may be formed from a single sheet of MDF that is typically 4 feet by 8 feet and ½ to ¾ inches thick.

It is yet a further object of the present invention to provide a method for machining a decorative pattern to the top edge of a baseboard that may be formed from a board natural wood that is typically 6 inches by 8 feet and ½ to ¾ inches thick.

Yet another object of the present invention is to provide a method for manually applying and cutting a decorative pattern to the top edge of a baseboard using a woodworking router.

### BRIEF SUMMARY OF THE INVENTION

The present invention discloses various method embodiments for applying a decorative pattern along the top edge of a baseboard that was lacking in the prior art.

In the preferred embodiment the decorative patterns will first be designed using Computer Aided Drafting (CAD) software. The design will be such that the patterns will repeat on the boundary of the wood material that is to be used in fabricating the baseboard so that when the individual baseboards are joined end to end the decorative pattern will not be interrupted. Once the design has been completed the CAD file will need to be converted into a format that is readable by a Computer Numerically Controlled (CNC) wood router machine hereafter referred to simply as a CNC machine. A CNC machine contains a larger flat surface, hereafter referred to as the table, whereon the wood material to be cut is placed, a means for securing the wood on the table, a moveable head containing a cutting tool that operates in three axises over the flat surface and engages the cutting tool with the wood material, and a computer that reads a computer file containing a set of programming instructions for the movement and travel speed of the head along any of the three axises: length, width, and height; the selection of the cutting tool to be used on the wood material; and the rotational speed of the cutting tool mounted to the head. A sheet of the wood material to be cut upon by the CNC machine is then placed on the flat surface of the CNC machine and secured either by a vacuum seal or by rollers that pin the wood material to the flat surface where it may be operably engaged by the cutting tool. The CAD converted file containing the programming instructions that are readable by the CNC machine is then read by the CNC machine whereupon the pattern depicted in the CAD file is cut onto the wood material forming one or more baseboards with a decorative pattern present along its top edge.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Neither this summary nor the following detailed description defines or limits the invention. The invention is defined by the claims.

### BRIEF DESCRIPTION OF DRAWINGS

The present invention will become more fully understood from the detailed description and accompanying drawings, wherein:

FIG. 1 is a perspective view of a CNC machine that implements a vacuum pump system to secure the wood material.

FIG. 2 is a side view of a CNC machine that implements a roller hold down system to secure the wood material.

FIG. 3 shows a sample CAD drawing containing 8 baseboards to be made from one 4 feet by 8 feet sheet of MDF material, a sample listing of G-Code used by CNC machines, and a process to convert the CAD drawing to G-Code.

FIG. 4 shows the method of the preferred embodiment of the present invention.

FIG. 5 shows the method of a secondary embodiment of the present invention.

FIG. 6 shows the method of another secondary embodiment of the present invention.

### DETAILED DESCRIPTION OF THE INVENTION

The following descriptions of the embodiment(s) is merely exemplary in nature and is in no way intended to limit the invention, its application, or uses.

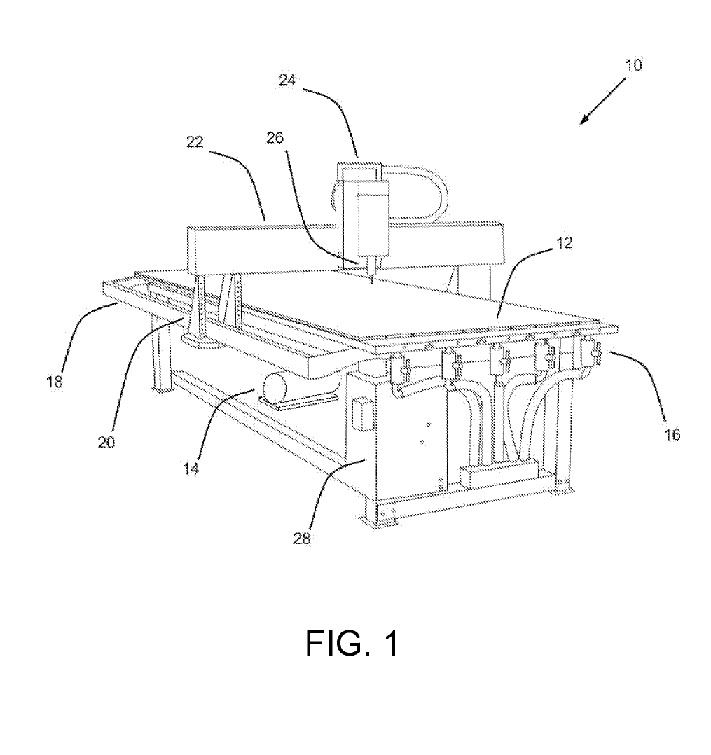

FIG. 1 is a perspective view of CNC machine 10 that implements a vacuum pump system to secure the wood material that is to be worked upon. Many details have been removed so as to focus on the primary components. The largest single component of CNC machine 10 is table 12. The purpose of table 12 is to provide a surface area to receive wood material that is to be worked on by CNC machine 10. By providing a large surface area table 12 may accommodate larger sheets of wood material so as to allow a greater number of baseboards to be created simultaneously. To quickly and easily secure the wood material to table 12 CNC machine 10 uses vacuum pump 14 to create a pressure differential between the table and the wood material and securely, but not permanently, hold the wood material while it is being worked on. If the wood material does not cover the width of table 12 then vacuum valves 16 may be individually adjusted so as to properly secure the wood material on table 12 without undue effort by vacuum pump 14. Lengthwise along table 12 on either side are guide rails 18. In FIG. 1 only one of the two guide rails 18 are visible. Guide rails 18 support the movement of gantry mounts 20 along the length of table 12 by the use of computer controlled electric motors thus providing one of the axes of movement, the X axis, for router 26. Gantry mounts 20 support gantry 22 and allows gantry 22 to move over the entire length of table 12. Gantry 22 contains one or more computer controlled electric motors that allow for the travel of router mount 24 along the length of gantry 22 providing a second axis of movement, the Y axis, for router 26. Router mount 24 supports router 26 and contains one or more computer controlled electric motors so as to move router 26 along a path that is perpendicular to table 12 providing a third axis of movement, the Z axis, for router 26. All of the electric motors and router 26 are controlled by numeric controller 28 which when activated begins to sequentially execute a set of instructions that was received from a computer which is not shown in FIG. 1.

An operator of CNC machine 10 typically would first load numeric controller 28 with the desired set of instructions, then place the sheet of wood material to be cut according to the loaded instructions on table 12, adjust vacuum valves 16 as required by the size of the sheet of wood material, engage vacuum pump 14 so as to secure the wood material being worked on, and finally activate numeric controller 28 to initiate the execution of previously loaded set of instructions. Numeric controller 28 will then activate the various motors to move router 26 to the desired location, and appropriately energize router 26 to commence the cutting operations contained in the instructions.

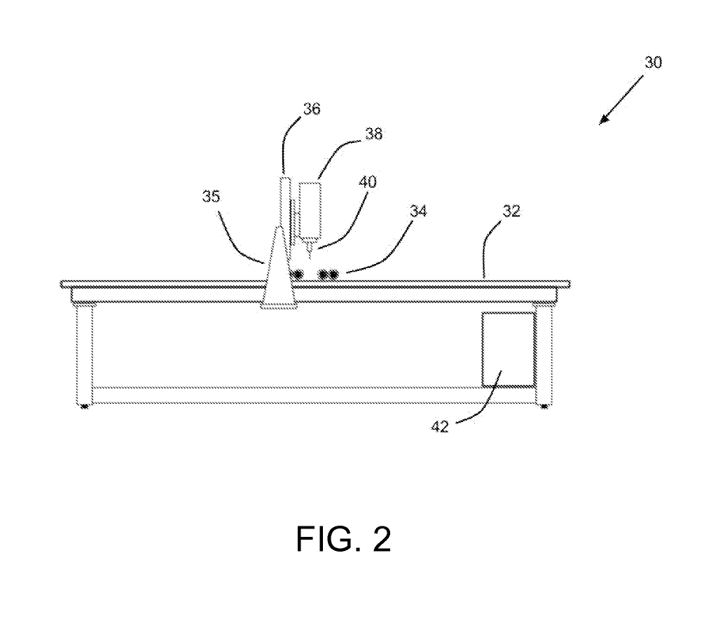

FIG. 2 shows a side view of CNC machine 30 that is similar in every aspect to CNC machine 10 but for that fact that CNC machine 30 implements a roller hold down system to secure the wood material that is to he worked upon as opposed to CNC machine's 10 vacuum system. Many details have been removed so as to focus on the primary components. The largest single component of CNC machine 30 is table 32. The purpose of table 32 is to provide a surface area to receive wood material that is to be worked on by CNC machine 30. By providing a large surface area table 32 may accommodate larger sheets of wood material may be worked on so as to allow a greater number of baseboards to be created simultaneously. To quickly and easily secure the wood material to table 32 CNC machine 30 uses hold down rollers 34, positioned on either side of router 40, to clamp the wood material to table 32 while it is being worked on. Hold down rollers 34 operate with equal effectiveness on wood material of different widths so as to enable CNC machine 30 to cut wood material made of natural wood that is 6 inches in width to wood material made of MDF and is 48 inches in width. Lengthwise along table 32 on either side are guide rails, not visible in this view, that support the movement of gantry mounts 35 along the length of table 12 by the use of computer controlled electric motors thus providing one of the axes of movement, the X axis, for router 40. Gantry mounts 35 support gantry 36 and allows gantry 36 to move over the entire length of table 32. Gantry 36 contains one or more computer controlled electric motors that allow for the travel of router mount 38 along the length of gantry 36 over the width of table 32 providing a second axis of movement, the Y axis, for router 40. Router mount 38 supports router 40 and contains one or more computer controlled electric motors so as to move router 40 along a path that is perpendicular to table 32 providing a third axis of movement, the Z axis, for router 40. All of the electric motors are controlled by numeric controller 42 which when activated begins to sequentially execute a set of instructions that was received from a computer which is not shown in FIG. 2.

An operator of CNC machine 30 typically would first load numeric controller 42 with the desired set of instructions, then place the sheet of wood material to be cut according to the loaded instructions on table 32, adjust hold down rollers 34 as required by the size of the sheet of wood material so as to secure the wood material being worked on, and finally activate numeric controller 42 to initiate the execution of the previously loaded set of instructions. Numeric controller 42 will then activate the various motors to move router 40 to the desired location, and appropriately energize router 40 to commence the cutting operations contained in the instructions.

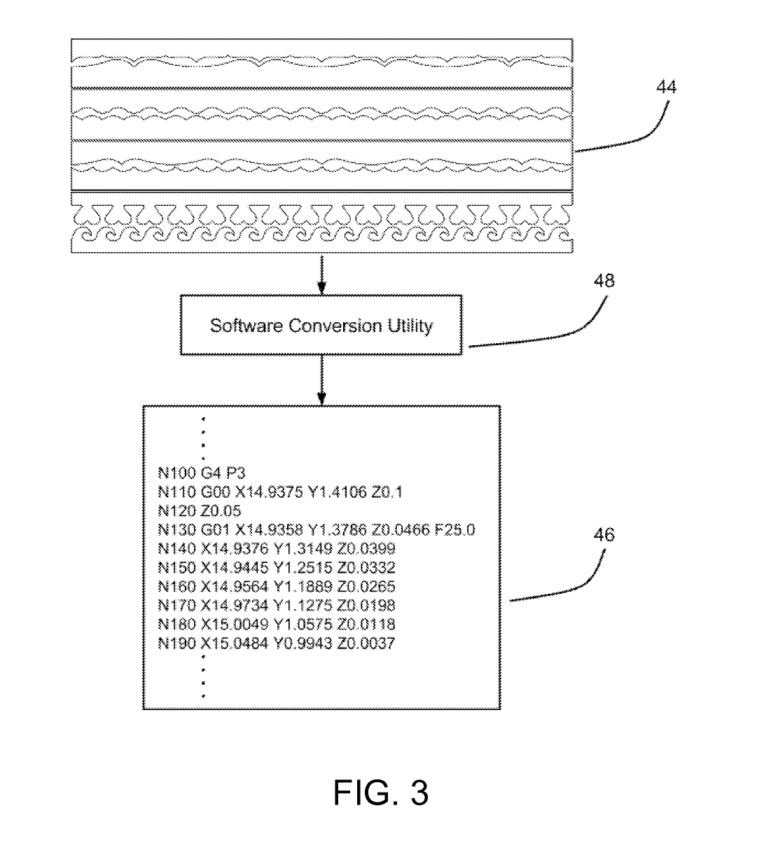

FIG. 3 shows CAD drawing 44 of a single sheet of MDF that is sized at 4 feet by 8 feet containing designs for 8 baseboards with a different decorative pattern along the top edge of each baseboard. CAD drawings may contain different decorative patterns on baseboards to be created or the pattern may be identical across all of the baseboards. Additionally the design may be for other shapes and sizes of wood material such as a single board that is 6 inches in width and 8 feet in length. There are many different CAD software programs that may be used but it is common for the file created from CAD programs to be in the Data Exchange Format (DXF) popularized by the CAD software AutoCAD®. However CNC machines are not able to read and understand information in a DXF file and alternatively use a set of codes, referred to as “G-Codes”, for use in controlling the various electrical motors used to guide the router along the X (length), Y (width), and Z (height) axises. A representative portion of a sample listing of G-Code codes is shown as G-Code listing 46. To convert CAD drawing 44 to G-Code listing 46 conversion utility 48 must be used. Conversion utility 48 will analyze CAD drawing 44 and create G-Code listing 46 that when loaded into CNC machine's numeric controller and executed will result in the design in CAD drawing 44 to be cut into the MDF sheet and from the one MDF sheet 8 baseboards containing a decorative pattern along its top edge are created.

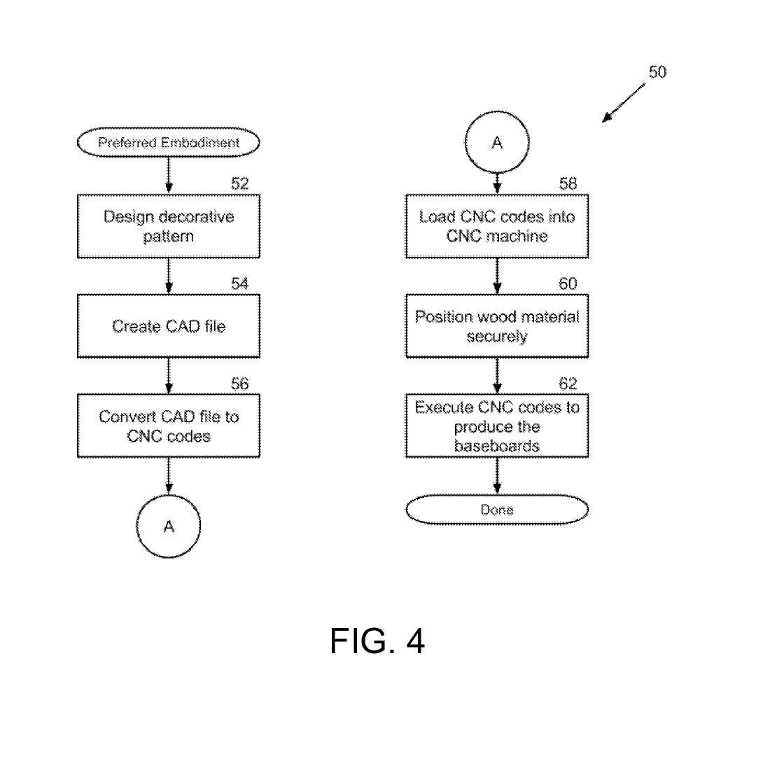

FIG. 4 shows the method of preferred embodiment 50. In step 52 a design of the decorative pattern to be used on the top edge of a baseboard is created using CAD software. There are many limitations on the design such as the height of a baseboard is typically less than six inches, the decorative pattern should withstand robust handling so that elements within the pattern are not susceptible to breakage, the decorative pattern repeats on a interval that is a common factor of the length of the wood material to be used so that the decorative pattern will restart itself when baseboards are connected end to end, and more. In step 54 the decorative pattern designed in step 52 is saved as a CAD file that is typically in the DXF format or some other format that is readable by a G-Code conversion utility program. Step 56 will convert the CAD file created in step 54 into a sequence of G-Codes that may be executed by numeric controllers in CNC machines. In step 58 the G-Codes created in step 56 are loaded into the CNC machine. In step 60 the wood material to be used in making the baseboard is placed on the CNC machine's table and secured to prevent movement while being worked on by the CNC machine's router. Now that the G-Code instructions have been loaded into the numeric controller and the wood material is ready to be worked on step 62 will engage the numeric controller to execute the instructions and cut the decorative pattern along the p edge of the baseboard in accordance with the design conceived of in step 52. Step 58 may be performed in parallel with step 60.

Since G-Codes are difficult to program and require skills that are beyond those skills necessary to create CAD files the preferred embodiment shown in FIG. 4 is appealing as it eliminates the need to have the skills required to create G-Code as the conversion process described in step 56 perform this task. This embodiment will also work with CNC machines using either vacuum system or hold down rollers and with wood materials using MDF sheets or boards of natural wood.

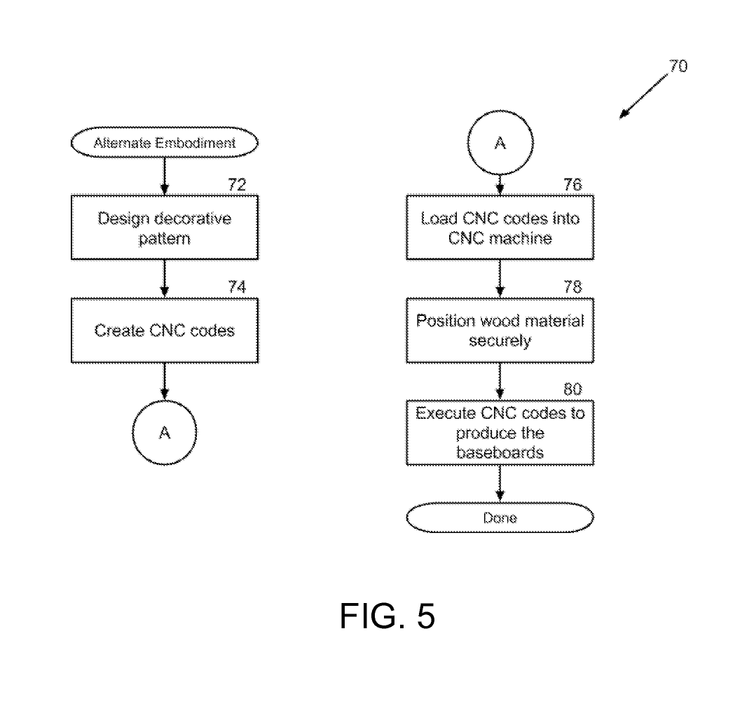

FIG. 5 shows the method of secondary embodiment 70. In step 72 a design of the decorative pattern to be used on the top edge of a base is created. There are many limitations on the design such as the height of a baseboard is typically less than six inches, the decorative pattern should withstand robust handling so that elements within the pattern are not susceptible to breakage, the decorative pattern repeats on a interval that is a common factor of the length of the wood material to be used so that the decorative pattern will restart itself when baseboards are connected end to end, and more. In contrast with preferred embodiment 50, secondary embodiment 70 will encode the design created in step 72 directly into a sequence of G-Codes that may be executed by numeric controllers in CNC machines in step 72. In step 76 the G-Codes created in step 74 are loaded into the CNC machine. In step 78 the wood material to be used in making the baseboard is placed on the CNC machine's table and secured to prevent movement while being worked on by the CNC machine's router. Now that the G-Code instructions have been loaded into the numeric controller and the wood material is ready to be worked on step 80 will engage the numeric controller to execute the G-Code instructions that have been loaded and cut the decorative pattern along the top edge of the baseboard in accordance with the design conceived of in step 72. Step 76 may be performed in parallel with step 78.

Although embodiment 70 requires the skills of a CNC machinist who is versant in G-Code there is the advantage of a greater level of control over the G-Code that is loaded into the numeric controller. In embodiment 50 the G-Code is created by a software application that understands the structure of a CAD file and can properly create the G-Code that implements the design contained in the CAD file. As such embodiment 50 is bounded by any inefficiencies in the G-Code that is created in step 56. In embodiment 70 the machinist may overcome any inefficiencies when creating the G-Code. As a result the cutting of baseboards in embodiment 70 may take less time than the cutting of baseboards in embodiment 50.

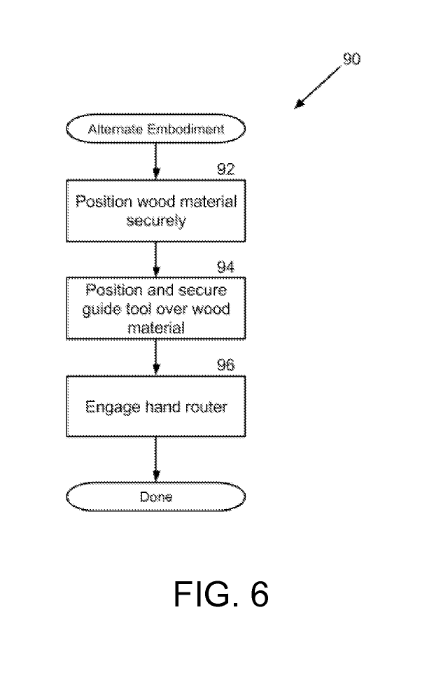

FIG. 6 shows the method of another secondary embodiment 90. In this embodiment a baseboard created from embodiment 50 or 70 is to be used as a guide tool for creating new baseboards. In step 92 the wood material to be used is secured to a table surface. In step 94 the guide tool is positioned and secured to the wood material by any number of means. In step 96 a hand held router tool is then moved along the edge of the guide tool to create a new baseboard with the same decorative edge as the decorative edge present in the guide tool.

Embodiment 90 has certain advantages and disadvantages over embodiments 50 and 70. The primary advantage is that embodiment 90 does not use a CNC machine in any of its steps and as such it is a less expensive to implement than embodiments 50 and 70. Another advantage is that it allows baseboards with a decorative top edge to be created outside the presence of CNC machines in situations where only a few additional baseboards are required to complete the job.

The previous descriptions of the various embodiments is provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments discussed herein, but is to be accorded the widest scope consistent with the principles and novel features disclosed herein.

What is claimed is:

1. A method for making a baseboard containing a decorative pattern along its top edge using
a computer;
a CNC router machine;
software that can create a computer file containing instructions for said CNC router machine to execute; and
baseboard material suitable for use as said baseboard;
comprising the steps of
designing said decorative pattern to be cut along the top edge of said baseboard;
creating a sequence of instructions that implements said decorative pattern that are readable by said CNC router machine;
saving said sequence of instructions into a computer file that may be read by said CNC router machine;
loading said computer file into said CNC router machine;
positioning said baseboard material onto said CNC router machine; and
engaging said CNC router machine to cut said decorative patterns as programmed by instructions contained in said computer file onto said baseboard material.

2. The method of claim 1 wherein said baseboard material is a sheet of MDF wood material.

3. The method of claim 1 wherein said baseboard material is a sheet of natural wood material.

4. The method of claim 1 wherein said step loading said computer file into said CNC router machine is performed in parallel or after said step positioning said baseboard material onto said CNC router machine.

5. The method of claim 1 where said decorative pattern is repeated in such a manner such that when said baseboard is assembled end to end with another said baseboard the decorative pattern is not interrupted.

6. The method of claim 1 wherein said sequence of instructions is a sequence of G-Codes.

7. A method for making a baseboard containing a decorative pattern along its top edge using
a computer;
a CNC router machine;
CAD software;
conversion software that will convert a file created by said CAD software into a file containing instructions for said CNC router machine to execute; and
baseboard material suitable for use as said baseboard;
comprising the steps of
designing said decorative pattern to be cut along the top edge of said baseboard;
creating CAD software file that contains said decorative pattern;
converting said CAD software file using said conversion software into a sequence of instructions that implements said decorative pattern and are readable by said CNC router machine and saving the instructions into a computer file;
loading said computer file into said CNC router machine;
positioning said baseboard material onto said CNC router machine; and
engaging said CNC router machine to cut said decorative patterns as programmed by instructions contained in said computer file onto said baseboard material.

8. The method of claim 7 wherein said baseboard material is a sheet of MDF wood material.

9. The method of claim 7 wherein said baseboard material is a sheet of natural wood material.

10. The method of claim 7 wherein said step loading said computer file into said CNC router machine is performed in parallel or after said step positioning said baseboard material onto said CNC router machine.

11. The method of claim 7 where said decorative pattern is repeated in such a manner such that when said baseboard is assembled end to end with another said baseboard the decorative pattern is not interrupted.

12. The method of claim 7 wherein said sequence of instructions is a sequence of G-Codes.

13. A method for making a baseboard containing a decorative pattern cut along its top edge using
a guide tool containing said decorative pattern;
baseboard material suitable for use as a baseboard; and
a hand router
comprising the steps of
securing said baseboard material onto a surface;
securing said guide tool over said baseboard material; and
engaging said hand router to cut said decorative pattern present on said guide tool into said baseboard material.

14. The method of claim 13 wherein said baseboard material is a linear board of natural wood.
